(19) United States
(12) Patent Application Publication
(10) Pub. No.: US 2022/0117169 A1
(43) Pub. Date: Apr. 21, 2022

(54) LOW VOLTAGE POWER DISTRIBUTION

(71) Applicants: James G. Wilson, Medfield, MA (US); Gerald C. Antoine, Pembroke, MA (US); Robert A. Adams, North Easton, MA (US)

(72) Inventors: James G. Wilson, Medfield, MA (US); Gerald C. Antoine, Pembroke, MA (US); Robert A. Adams, North Easton, MA (US)

(21) Appl. No.: 17/075,584

(22) Filed: Oct. 20, 2020

(51) Int. Cl. A01G 9/26; A01G 7/04; H01R 13/52; H01R 13/713

(52) U.S. Cl. CPC A01G 9/26; H01R 13/713; H01R 13/52; A01G 7/045

(57) ABSTRACT

An indoor growing environment for growing plants wherein due to the nature of the growing conditions the area is wet. If a high voltage device is in the growing environment near the water ground-fault protection is needed. To avoid the use of ground-fault protection, certain devices in the growing environment are powered by low voltage and the conversion to low voltage from a higher voltage is performed away from the immediate plant growing area or outside of the grow room

### CROSS-REFERENCE TO RELATED APPLICATIONS

This application claims the benefit of U.S. provisional patent application entitled “Low Voltage Power Distribution” filed, May 17, 2018 and assigned Ser. No. 62/672,852, which is incorporated by reference in their entireties.

### BACKGROUND OF THE INVENTION

### 1. Field of the Invention

The invention is directed to indoor farming and more specifically to growing plants in an indoor environment such as a clean room wherein the radiant energy provided to the plants is artificially produced and controlled. More specifically, this invention is directed to solving the problems that arise when high voltage is present in a wet growing environment by separating the power conversion to outside of the grow room to avoid the need for ground-fault protection inside the grow room.

### 2. Description of the Prior Art

When growing plants indoors, there are numerous pieces of equipment including lights, pumps, automated equipment, monitoring equipment, aerators, etc. requiring electricity, specifically high voltage electricity. However, water is also involved in growing plants thus creating hazardous conditions with the possibility of causing shock. To avoid any dangerous conditions and injuries, GFCIs are utilized wherever water or moist conditions and electricity may come into contact.

It is now well known that plants grow when exposed to light composed of certain specific wavelengths. Exposing the plants to other wavelengths is not helpful and in certain cases counterproductive. Various LED lighting appliances have been developed that efficiently produce light of the desired appropriate wavelengths. Within each of these appliances is a device that converts power from the available line voltage to the operating voltage of the lighting circuitry. They also contain circuitry to rectify the power and limit the current to optimally drive the LEDs. These have been packaged such that line voltage must be delivered to or near each of the lighting appliances. The appearance of line voltage within the wet and humid growing environment of a clean room gives rise to a multitude of safety and logistical problems. When high voltage is used, most electrical codes require use of ground-fault interrupting circuitry. This lessens the safety concerns but introduces the possibility that lights may be inadvertently turned off by a fault. When lights are turned off during a growing cycle the plants may be damaged, and the yield and quality of the crop may be diminished.

When growing plants indoors, a system of racks is utilized. Within each rack are several rows of plants wherein there is a tray holding water and supporting floats supporting plants. Pumps continually pump water to one end of the trays and the water flows across the trays and out the opposite end of the trays down to a reservoir. If the pump gets wet or another electrical system in the room gets wet, the electrical system may shut down in the whole room. Depending on the length of the shutdown and the pumping system being utilized, the trays my drain complete causing drying roots, or causing the roots to rot due to no water flow or the draining system could spill all over the floor.

### SUMMARY OF THE INVENTION

When growing plants in a clean room, numerous pieces of apparatuses including lights, pumps, various automated equipment, aerators, monitoring equipment, etc. require electricity. Water is also a necessity when growing plants. It has been documented in various literature of the severity and dangerousness to have water proximate to any equipment requiring electricity.

An object of the invention is to separate the conversion from dangerous line voltage or high voltage to safe low voltage away from the rest of the driving circuitry of the LED appliances. In the United Stated high voltage is defined as any voltage above 48 volts. This invention places the conversion circuitry outside of the growing environment where it can be properly grounded and does not need ground-fault protection. The low-voltage current limiting circuitry is placed within the grow room and requires no ground-fault protection. Wires carry the isolated low voltage current into the grow room and to the lighting appliances, pumps, automated equipment, monitoring equipment, aerators, etc. This eliminates the possibility that the wet environment within the grow room could trigger a ground fault that causes the lights and power to the room to be turned off. Thus, there is no high voltage inside the growing or processing areas where water is possibly present. Only low current is utilized within these areas and any line voltage is outside these areas. Thus no GFCI devices are needed eliminating the shutdown of electricity in these areas which shutdowns can harm the growth of the plants.

### BRIEF DESCRIPTION OF THE DRAWINGS

Other objects, features and advantages of the present invention will become more apparent as the description proceeds with reference to the accompanying drawings wherein:

FIG. 1 illustrates a growing rack that houses growing plants and contains lighting appliances that provide essential light to the plants.

FIG. 2 is a schematic diagram illustrating the separation of line voltage to low voltage conversion and current limiting and LED driving circuitry.

FIG. 3 shows a pump that is powered by low voltage and where the low voltage is produced by a power supply or transformer situated outside of the grow room.

### DETAILED DESCRIPTION OF THE INVENTION

Example embodiments will be more fully understood from the illustrations and detailed description hereinbelow.

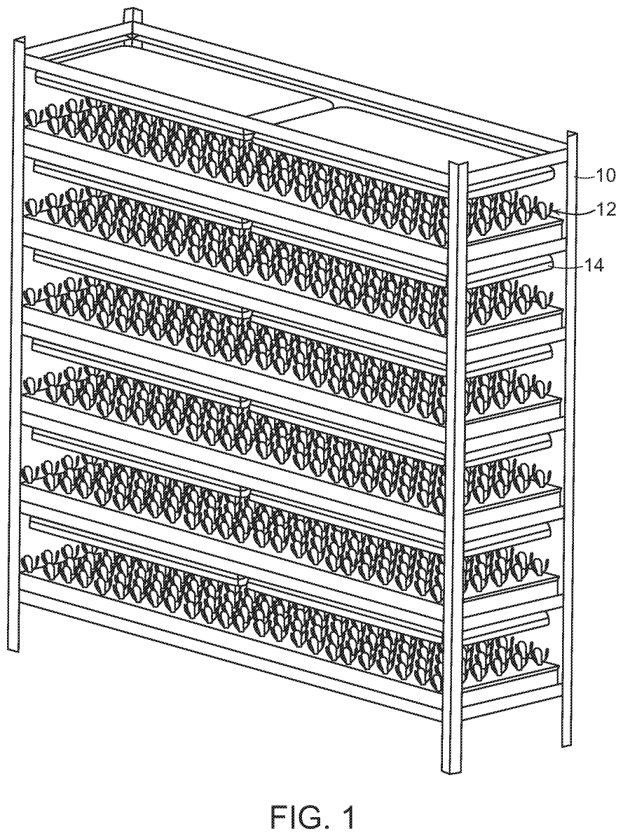

As illustrated in FIG. 1 is a growing rack (10) maintaining racks of plants (12) and lighting appliances (14). The lighting appliances (14) shine the appropriate wavelengths of light onto the plants being grown (12) thereon.

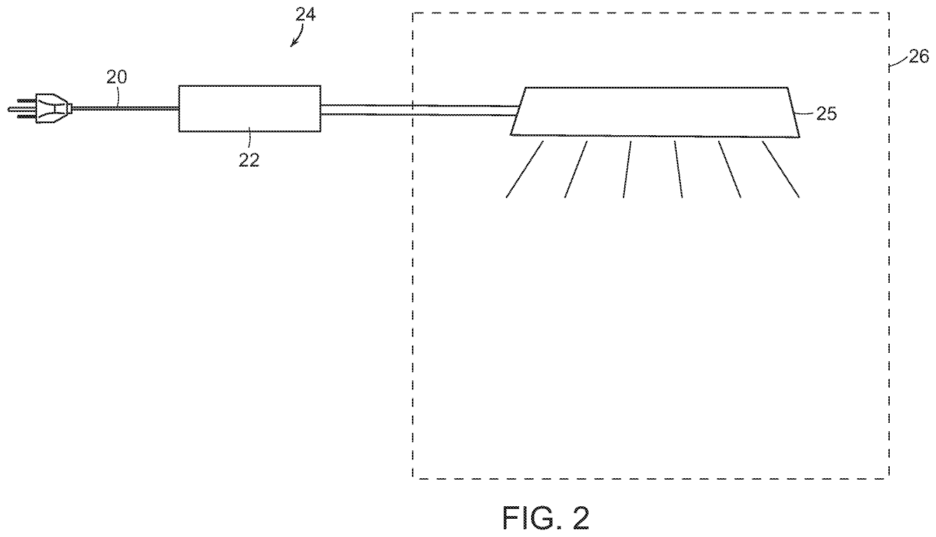

FIG. 2 illustrates a line 20 providing high voltage power that is transformed to a lower voltage by a transformer, power supply 22 or by some other means. A pair of conductors 24 to transport low voltage power from outside of the grow room 26 to inside of the grow room is shown. Depicted at 25 is an appliance or piece of equipment such as lighting which is powered by low voltage located inside the grow room.

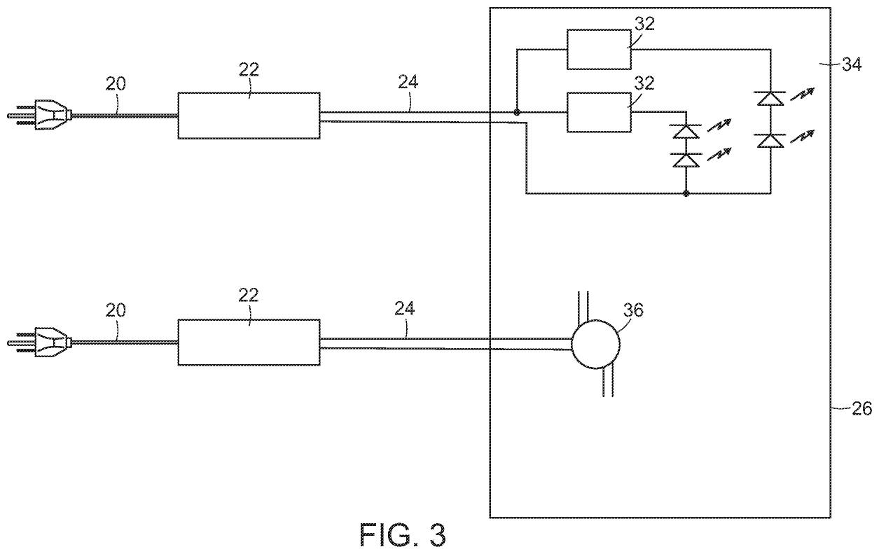

Illustrated in FIG. 3 are two lines providing high voltage power which are transformed to lower voltage before entering the grow room and the conductors transporting the lower voltage to inside the grow room. A current limiting device 32 such as those used to drive a string of LED lights 34 is shown. Other appliances such as pumps will not require the use of such a device. A pump is shown at 36 inside the grow or clean room 26 that is run by low voltage power.

In one embodiment of the invention, control circuitry that turns on and off line voltage to power supplies and the power supplies themselves were placed on the roof of a grow room, outside of the wet environment. The roof and the power supplies themselves were grounded in such a manner that any ground fault or failure of the circuitry would be isolated from wet environment that exists within the grow room. Pairs of wires conducted low-voltage power from the power supplies outside of the grow room to the lights within the grow room. The lights on each rack were powered by one or more pairs of wires. These wires conduct electricity at a potential of 24 volts and at a current that is sufficiently low to prevent any fire hazard. Twenty-four volts is a voltage that is considered safe to humans and that requires no ground-fault protection. The wires are electrically isolated from any source of high voltage and so do not give rise to the requirement for ground-fault protection. The circuitry within each of the light appliances further limits the current through a string of LEDs to produce the optimal irradiance. The result is that the system is immune to ground-fault problems that might cause interruption of lighting during a grow cycle. The circuitry controls and power supplies may be located wherever it is feasible.

In other embodiments various other devices such as pumps, monitoring systems, computers, computing devices, annunciators, warning lights automated devices, aerators and the like may also be powered in the same manner to avoid ground-fault issues.

In the grow room, most critical devices, i.e. devices that if shut off would harm the growth of the plants, would be powered by low voltage and wherein high or line voltage would be only used for devices that may be inadvertently turned off without negatively impacting growth of the plants. Other AC or DC voltages may be used as the ‘low voltage’ so long as the ‘low’ voltage is below the potential that is considered dangerous to humans.

Some types of equipment, i.e. automated packaging equipment, specific pumps, fans, etc. may still require high or line voltage. Thus, there may be multiple sources of power into the grow room. These devices would require a GFCI.

Power may be converted in multiple stages so long as the grow room contains no dangerous voltages to power critical devices. Dangerous voltage with ground-fault protection circuitry is allowable within the grow room so long as equipment whose use must not be interrupted is not powered by it.

Local building codes should always be followed with all electrical plans.

Although the present invention has been shown and described with respect to several preferred embodiments thereof, various changes, omissions and additions to the form and detail thereof, may be made therein, without departing from the spirit and scope of the invention.

What is claimed is:

1. An artificially controlled environment for growing and processing plants, the artificially controlled environment comprises a power distribution for powering devices within the artificially controlled environment wherein the devices are locally powered by electricity at a low voltage and where conversion from line voltage to the lower voltage is performed outside of the artificially controlled environment and wherein no voltage above 48 volts AC or DC enters the artificially controlled environment including the processing or growing areas.

2. The artificially controlled environment of claim 1, wherein the artificially controlled environment is absent any source of high voltage.

3. (canceled)

4. The artificially controlled environment of claim 1, wherein safety from electrical shock is maintained without the use of ground-fault interruption equipment that might interrupt power to devices that impact the growth of plants.

5. The artificially controlled environment of claim 1, wherein the devices include lights to illuminate the plants.

6. An artificially controlled environment for growing and processing plants, the artificially controlled environment comprises a power distribution for powering low voltage lighting within the grow room wherein the lighting is locally powered by electricity at a low voltage and where conversion from line voltage to the lower voltage is performed outside of the artificially controlled environment including the growing and processing areas.

7. A plant growing and processing environment, said plant growing and processing environment includes devices powered by low voltage, conversion to said low voltage from a higher voltage is performed away from the immediate plant growing area.

8. The plant growing and processing environment of claim 7, wherein the conversion from high to low voltage is performed outside the grow room.

9. The artificially controlled environment of claim 1, wherein the environment includes areas for growing and processing plants.
